(19) United States
(12) Patent Application Publication
(10) Pub. No.: US 2002/0185454 A1
(43) Pub. Date: Dec. 12, 2002

(54) Full flow particulate and acid-neutralizing filter

(76) Inventors: John H. Beard, Kearney, NE (US); Allan Roush, Thorntown, IN (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/859,939

(22) Filed: May 17, 2001

(51) Int. Cl. B01D 35/02; B01D 37/00

(52) U.S. Cl. 210/749; 210/767; 210/206; 210/440

(57) ABSTRACT

The present invention provides a filter apparatus for use in removing acids and particulate impurities contained in a fluid such as the oil contained in the oil circulation system for a diesel engine. In one embodiment, the filter apparatus includes an outer canister, an inner shell, and a particulate filter and an acid-neutralizing compound contained within the inner shell.

### FIELD OF INVENTION

The present invention relates to a method and apparatus for filtering impurities and neutralizing acid found in fluids in fluid circulating systems. More particularly, the invention is directed to a method and full flow apparatus for removing particulates and acids from oil in an oil circulating system such as the oil system associated with a diesel engine.

### BACKGROUND OF THE INVENTION

In various kinds of apparatuses utilizing fluids (for example lubrication oil), fine particulate impurities may find their way into the fluid. If such impurities are not removed, the apparatus, such as an engine, may be damaged. To avoid such catastrophic failures, various kinds of filtering systems have been proposed. In the most usual filtering systems, a filter is commonly inserted into the main circulation system. Main circulation system filters generally have a low density.

Heavy-duty diesel engine life, or time to rebuild, has historically been linked directly to piston ring, cylinder liner or crankshaft bearing life. Engine design parameters require that these engine components be hydrodynamically lubricated, i.e., operate with a film of lubricant separating these engine components from associated metal surfaces. Consequently, the principle mechanism associated with piston rings, cylinder liners and crankshaft journal bearings wear is not metal-to-metal contact or frictional wear. The primary diesel engine wear mode influencing engine life is corrosive wear caused by sulfur and nitrogen containing acids formed during the diesel fuel combustion process. One estimate is that more than 70 percent of heavy-duty diesel engine wear is caused by combustion acid metal corrosion.

Control of diesel engine corrosive wear has historically been accomplished through inclusion of basic or alkaline chemicals within the engine oil that is utilized to form the hydrodynamic lubricant film. These alkaline components rapidly neutralize or solubilize combustion acids upon contact with the acid molecules. The effectiveness of the corrosive wear control is entirely dependent upon the probability of the acid being neutralized by alkaline oil components prior to contact of the acid with engine metal surfaces resulting in corrosive wear. The amount of engine corrosive wear can typically be monitored through the use of oil analysis where cylinder liner wear is associated with iron parts per million (ppm) level in the engine oil. Piston ring wear is monitored by chromium levels and crankshaft bearing wear is reflected by lead levels in the oil.

The corrosive wear process begins in the diesel engine combustion chamber where the hydrocarbon diesel fuel containing sulfur compounds is combusted in the presence of oxygen and nitrogen. The hydrocarbon fuel is converted to principally carbon dioxide and water, creating extremely high gas pressures, which push down on the top of the piston to produce engine power. Also produced are SOₓ and NOₓ compounds, which rapidly react with the water released during fuel combustion yielding primarily sulfuric acid and nitric acid. These acids reach engine metal surfaces by direct contact in the cylinder bore or as blow-by gases as a normal part of engine operation. The hydrodynamic lubricant film present in the piston ring belt zone will also transport acid molecules throughout the engine as the lubricant is constantly circulated.

Combustion acid neutralization is completed using a simple acid-base reaction where metal carbonates carried as alkaline components within the lubricant directly react with sulfuric and nitric acids. The effectiveness of corrosive wear control is totally dependent upon the probability of these metal carbonates coming in contact with the acid molecules before these same molecules contact engine metal surfaces. Another factor influencing the rate and efficiency of acid neutralization is acid solubilization within the lubricant by another oil additive classified as an ashless dispersant. Dispersants are long chain hydrocarbon polymers, which are functionalized by terminating the polymer chain with a functional group generally containing basic nitrogen. Dispersants will rapidly complex with combustion acids dispersing or solubilizing them within the lubricant for transportation to a metal carbonate where the acid is converted to a neutral metallic salt. The combined efficiency of dispersant acid complexing and metallic carbonate acid neutralization controls the rate of engine wear.

Overbased or alkaline metallic detergents have been widely utilized as metallic carbonate carriers in diesel engine oil compositions. Calcium and magnesium sulfonates and phenates account for the majority of the detergents utilized to formulate diesel engine oils. Overbased detergents are produced by incorporating extra calcium or magnesium within a physical structure called a detergent micelle. For example, alkylbenzenesulfonic when reacted with calcium hydroxide and blown with carbon dioxide during the reaction process will produce an overbased calcium sulfonate. The extra metal or calcium present in the detergent micelle structure is calcium carbonate surrounded by oil solubilizing calcium sulfonate detergents. This physical structure circulating within the oil delivers the calcium carbonate to the combustion acid molecules for acid neutralization.

Ideally, there should be no limit to the amount of alkaline detergent incorporated within a diesel engine oil formulation; however, in reality modern diesel engines can only tolerate a limited level of metallic detergents before metallic ash deposits cause piston ring sticking and exhaust valve guttering. These ash deposits are caused by pyrolysis of oil metal organo compounds, principally calcium and magnesium detergents.

Recognizing (1) most diesel engine wear is caused by acid corrosion, (2) the lubricant ash content is limited, and (3) newer diesel engine designs will incorporate exhaust gas recirculation where combustion acids will be concentrated and reintroduced into the engine, a system capable of neutralizing combustion acids without significantly altering diesel engine oil compositions while at the same time filtering solid impurities from the oil circulation system would significantly reduce engine wear including corrosive wear. This is especially true in the later half of an oil drain period when the lubricant's acid-neutralizing capability has been depleted.

### SUMMARY OF THE INVENTION

The present invention is directed to a system for extending the normal operating life of a fluid circulation system such as an oil circulation system associated with a diesel engine. The system includes an apparatus for assisting in the removal of acids which accumulate in the fluid, such as an oil, that is pumped through the circulation system. By removing such acids, the useful life of the circulating fluid may be extended thus lowering the operating costs. Preferably, the system of the invention includes a canister through which some or all of the circulating fluid passes. Within the canister is an acid-neutralizing compound which reacts with the acids in the circulating fluid to neutralize the acids and a particulate filter for removing particulates from the circulating fluid.

The apparatus for removing acids may be inserted into the full flow portion of the fluid circulation system or may be inserted into a bypass system. In either case, from a small portion up to all of the fluid being circulated may pass through the acid-neutralizing apparatus depending upon the desired acid neutralization rate.

In a preferred embodiment, the fluid circulation system is an oil circulation system and the fluid being filtered is oil.

The present invention provides a full flow filter canister for use in removing impurities contained in a fluid as well as neutralizing acids found in the fluid which includes a housing, a particulate filter component, and an acid-neutralizing component.

In one embodiment, a filter apparatus for use in removing impurities contained in a fluid comprising is provided. The apparatus includes a housing having a closed end and an open end. An inner shell having an open end and a partially closed end is contained within the housing. A perforated conduit is contained in the inner shell and a particulate filter is positioned within the inner shell and arranged concentrically around the perforated conduit. An acid-neutralizing compound contained within the inner shell is arranged concentrically around the particulate filter.

In an embodiment of the invention, the apparatus may include a lid which engages the open end of the inner shell. Preferably, the lid snaps into engagement with the shell and more preferably, the lid includes an outer seal for sealingly engaging the interior of the inner shell. The seal may be an o-ring seal.

Preferably, the particulate filter and perforated conduit are sealingly engaged by first and second end caps. Also, preferably, the acid-neutralizing compound is selected from the group consisting of crushed limestone, calcium carbonate, and magnesium carbonate.

Also, preferably, the filter apparatus of further comprises a spring located between the inner shell and the closed end of the housing.

Also provided is a filter apparatus for use in removing acids and impurities contained in a fluid by filtration which comprises a housing, an inner shell, a particulate filter contained in the inner shell, the particulate filter including filter media, a pre-filter surrounding the filter media, an acid-neutralizing compound within the inner shell and surrounding the particulate filter and pre-filter, and a base plate.

Preferably, the base plate is a combination base plate and seaming lid. Also, preferably, the acid-neutralizing compound is selected from the group consisting of crushed limestone, calcium carbonate, and magnesium carbonate.

In one embodiment, the base plate includes a central hub, an outer peripheral rim surrounding the hub, and a plurality of radially extending ribs connecting the hub and the rim. The central hub preferably defines a threaded central opening for spin-on connection to a fluid circulation system. Preferably, the central threaded opening of the base plate provides a central port for fluid returning to the fluid circulation system. Also, a plurality of peripheral ports are defined between the hub, the ribs and the peripheral rim to permit fluid to enter the filter from the fluid circulation system.

A method of removing impurities contained in a oil circulating in an oil circulation system is also provided. The method comprises:

(a) introducing the oil to a filtering apparatus including a housing and an inner shell; having within the inner shell, a particulate filter and an acid-neutralizing compound;

(b) passing the oil first into the housing and then into the inner shell;

(c) then passing the oil through an acid-neutralizing compound;

(c) next, passing the oil through a particulate filter; and

(d) passing the oil out of the inner shell and thereafter out of the apparatus, returning the oil to the oil circulation system.

Preferably in practicing the method, the acid-neutralizing compound is selected from the group consisting of crushed limestone, calcium carbonate, and magnesium carbonate.

### BRIEF DESCRIPTION OF THE DRAWINGS

FIG. 1 is a cross sectional view showing a first embodiment of the filtering apparatus of the claimed invention;

FIG. 2 is an exploded perspective view of components of the present invention;

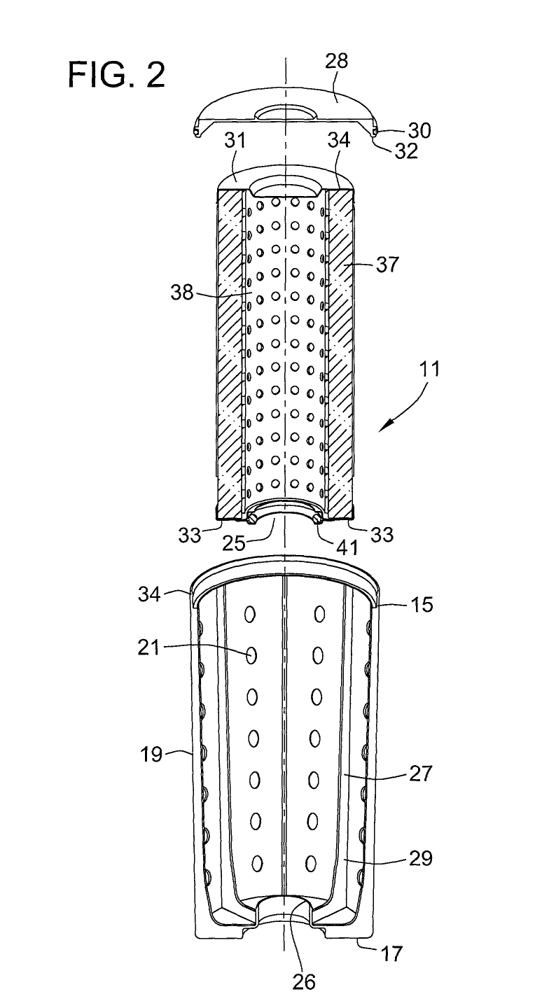

FIG. 3a is an enlarged view of the upper portion of the apparatus illustrated in FIG. 1.

FIG. 3b is an enlarged view of the lower portion of the apparatus illustrated in FIG. 1.

For purposes of an understanding of the invention, reference will now be made to the apparatus as shown in the figures and specific language will be used to describe the same. It will nevertheless be understood that no limitation of the scope of the invention is thereby intended, and that the apparatus shown therein represents only some of the features of the claimed invention.

### DETAILED DESCRIPTION OF THE INVENTION

The present invention is directed to a system for extending the normal operating life of a fluid circulation system such as an oil circulation system associated with a diesel engine. The system includes an apparatus for assisting in the removal of acids which accumulate in the fluid, such as an oil, that is pumped through the circulation system. By removing such acids, the useful life of the circulating fluid may be extended thus lowering the operating costs. For instance, with acid-neutralization as contemplated by the present invention, mileage on a diesel engine used to propel a typical diesel truck may be extened up to a total of 100,000 miles or more between oil changes. This interval is especially important in such systems where the fluid circulation system may contain as much as 100 gallons of oil.

Preferably, the system of the invention includes a canister through which some or all of the circulating fluid passes. Within the canister is an inner shell which contains an acid-neutralizing compound which reacts with the acids in the circulating fluid to neutralize the acids. Once the fluid circulates through the acid-neutralizing compound, the oil passes through a particulate filter which is also contained within the inner shell prior to returning to the oil circulation system.

The apparatus for removing acids may be inserted into the full flow portion of the fluid circulation system or may be inserted into a bypass system. In either case, from a small portion up to all of the fluid being circulated may pass through the acid-neutralizing apparatus depending upon the desired acid neutralization rate.

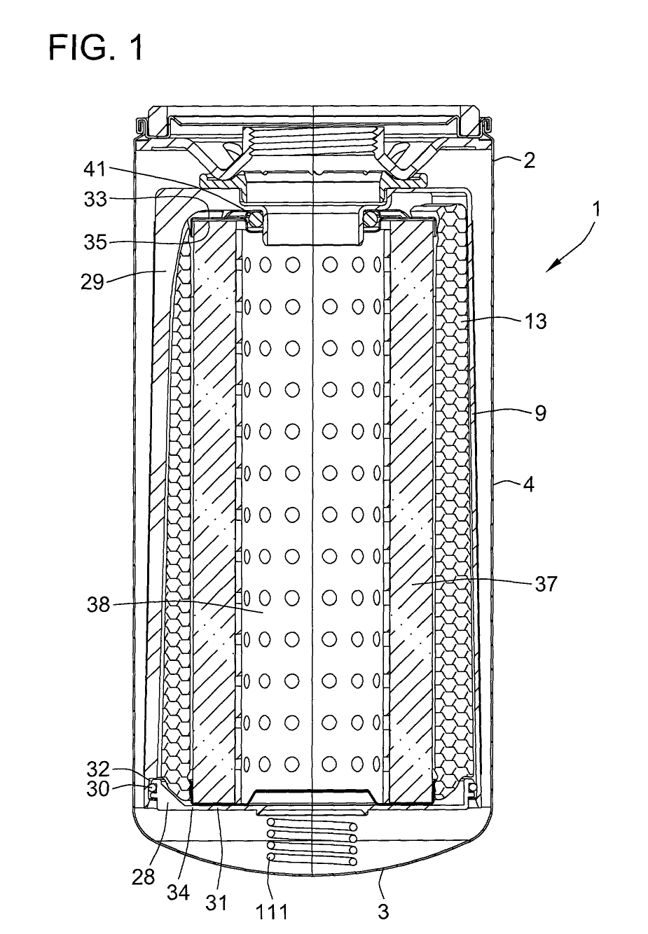

FIG. 1 illustrates a cross sectional view of a first embodiment of the full flow filtering and acid-neutralizing apparatus of the present invention for use in a fluid circulation system such as an oil circulation system for a diesel engine. The apparatus may be detachably secured to a block of an internal combustion engine for the filtering of lubricant oil. Preferably, the apparatus of the invention is attached through a spin-on connection although a bolt-on configuration or other common attachment schemes may be used.

The filtering apparatus comprises a housing 1, preferably in cylindrical form, having an open end 2 and a closed end 3, a sidewall 4. The housing 1 can be made of any suitable material depending on the intended use of the apparatus. Examples of suitable materials include steel, aluminum, or plastic. Preferably the housing is drawn from relatively heavy gauge steel to include the closed end 3, the open end 2 and the sidewall 4 which is preferably substantially cylindrical.

Housed within the housing 1, is an inner shell 9 which contains a particulate filter element 11 and the acid-neutralizing compound 13. The inner shell 9 includes an open end 15 and a partially closed end 17 and sidewalls 19. Passing through the sidewalls 19 are inlet ports 21. The shell 9 is preferably cylindrical in shape having an outside diameter of about 0.4 to about 1.0 inches less than the inside diameter of the housing 1. The shell 9 is preferably formed from steel, aluminum or a moldable plastic material such as nylon. The partially closed end 17 includes a central opening 25 through which the treated and filtered fluid exits the assembly. Extending inward into the shell and surrounding the central opening 25 is a lip 26. The lip preferably extends into the inner shell about 0.5 inches. Preferably, the inner shell 9 inner walls 27 include one or more ribs 29, and more preferably 8 ribs. The ribs assist in strengthening the inner shell as well as centering the particulate filter element 11.

Preferably, the inner shell sidewalls inlet ports 21 are covered, either on the inside or the outside of the shell, with a media designed to prevent any acid-neutralizing compound from passing through the ports and out of the inner shell 9. The media preferably comprises a synthetic porous material made of polyester or nylon or a wire mesh material made of stainless steel, openings 0.0005″ to 0.001″.

The open end 15 of the inner shell 9 is sealed by a lid 28. The lid 28 is provided with an o-ring 30 which is seated in a u-shaped channel 32 which extends around the periphery of the lid. The lid 28 is sealed to the inner shell 9 by snapping the o-ring 30 past an undercut 34 in the inner wall of the inner shell 9.

The particulate filter element 11 includes an upper end cap 31, a lower end cap 33, filter media 37 and a perforated inner support tube 38. The upper end cap 31 is imperforate and includes a u-shaped channel 32 for sealingly engaging the first ends of filter media 37 and a perforated inner suppport tube 38. The lower end cap 33 also includes a u-shaped channel 35 for sealingly engaging the second ends of the filter media 37 and perforated inner support tube 38. The center of the lower end cap 33 is open to permit filtered and treated fluid to flow out of the inner shell 9. The lower end cap 33 also preferably includes an an inward facing u-shaped channel 41 which holds an o-ring 43 which can engage and seal the particulate filter against the outer circumference of the conduit lip 26 extending inward from the central opening 25 which passes through the partially closed end 17.

The inward facing u-shaped channel 41 of both the lower end cap is preferably formed from a first inward facing shoulder 43 which is integrally molded with and extends from the inner u-channel wall 45. The outer side of the inner u-channel wall 45 preferably forms much of the bottom of the inward facing u-shaped channel 41. A z-shaped molded portion is preferably provided to form the second wall and a portion of the bottom of the inward facing u-shaped channel. The z-shaped portion includes an inward facing horizontal shoulder forming the second wall 49 of the inward facing u-shaped channels, a vertical wall 51 forming a portion of the bottom of the inward facing u-shaped channels, and a further horizontal outward extending wall 53. The outward extending wall 53 is used to join the z-shaped portion to the exterior of lower end cap 33 by glue, heat welding or spot welding.

The perforated inner support tube 38 establishes the center of the particulate filter element 11. The particulate filter media 37 is placed around the perforated inner support tube 38. The particulate filter media 37 is designed to prevent particles entrained in the fluid being filtered, including any acid-neutralizing compound particles from entering the fluid circulation system. The particulate filter media 37 is preferably in a pleated circular arrangement around the central perforated support tube 38. The particulate media 37 is composed of a material and designed so as to permit filtering of particulates from the fluid entering the filter. The media 37 may be formed from any suitable filter media. Examples of suitable filter media for the media 37 include cellulose, synthetic fiber, or micro-glass Preferably, the particulate media 37 is formed from micro-glass, synthetic fiber or other synthetic media. Also, preferably, the particulate media 37 is wrapped with a pre-filter comprising a synthetic porous material made of polyester or nylon or a wire mesh material made of stainless steel, openings 0.0005″ to 0.001″ to prevent the acid-neutralizing compound from invading the gaps between the pleats of the filter media. Alternatively, the particulate media 37 may be wrapped with a perforated support having greater strength than the pre-filter material.

The upper and lower end caps 31 and 33 are potted or otherwise sealingly engaged with the filter media and perforated inner support tube along with any pre-filter or outer perforated support using potting material such as plastisol or by epoxy. When the filter medias and inner support tube are sealed between the end caps, filtered fluid passes through the filter media 37, through the perforated inner support tube 38, and into the interior space defined by the interior walls of the perforated inner support tube 38.

To assemble the inner shell 9, the lower end of the filter element including the o-ring seal 43 is first inserted into the open end 15 of the inner shell. The remainder of the filter ement is inserted into the inner shell and the o-ring seal 43 is seated around the inner lip 26 extending inward into the inner shell 9 from the partially closed end 17 of the inner shell. In such a manner, the lower end of the inner shell is sealed.

Once the filter element 11 is seated in the inner shell 9, the acid-neutralizing compound may be added to the inner shell in the annulus 55 between the inner walls of the shell and the outer surface of the filter element 11. Preferably, the acid-neutralizing compound is a carbonate and more preferably calcium carbonate. Preferably, the acid-neutralizing 55 neutralizing compound is in the form of crushed limestone as this is a low cost, highly effective acid neutralizer. In addition to crushed limestone, acid-neutralizing compounds such as amorphous magnesium carbonate and amorphous calcium carbonate may be used.

Crushed limestone suitable for use in the acid-neutralizing filter of the present invention is available from Iowa Limestone under the tradenames Unical S and Unical F, by Franklin Industrial Mining under the designations C6×16 and C8×12, and by Great Lakes Mining under the designations 20×200 and 12×40. Table A, set forth below, illustrates the standard sieve properties of these products. Generally, the smaller the acid-neutralizing compound particles, the greater the surface area of the compound that is exposed to the fluid to be treated. The use of smaller particles thus increases the effectiveness of the treatment. The use of smaller particles also increases the pressure drop through the acid-neutralizing compound container. Therefore, the size of the particles selected should be balanced against the amount of pressure drop that can be tolerated across the container. Also, the degree of packing in combination with the particle size will impact both the amount of oil which may be moved through the acid-neutralizing canister as well as the pressure drop thus impacting on the materials used to construct the canister and its various components.

TABLE A
LIMESTONE SPECIFICATIONS

| | | U.S. Screen | % Passing |
|---|---|---|---|
| Company | Grade | Number | Screen |
| Iowa Limestone | Unical S | 25 | 100 |
| | | 45 | 98.5 |
| | | 70 | 68 |
| | | 100 | 44.5 |
| | | 200 | 12.5 |
| | Unical F | 8 | 90 |
| | | 16 | 9.5 |
| | | 25 | 2.5 |
| | | 45 | 1.5 |
| Franklin Industrial Min | C6 × 16 | 4 | 100 |
| | | 5 | 99.54 |
| | | 6 | 97.28 |
| | | 7 | 71.33 |
| | | 8 | 35.57 |
| | | 10 | 11.65 |
| | | 12 | 5.45 |
| | | 16 | 2.7 |
| | C8 × 12 | 8 | 90 |
| | | 16 | 9.5 |
| | | 25 | 2.5 |
| | | 45 | 1.5 |
| Great Lakes | 20 × 200 | 6 | 100 |
| | | 12 | 100 |
| | | 20 | 100 |
| | | 40 | 65 |
| | | 60 | 31 |
| | | 100 | 14 |
| | | 200 | 7 |
| | 12 × 40 | 6 | 100 |
| | | 8 | 100 |
| | | 20 | 39 |
| | | 40 | 6 |
| | | 60 | 1 |
| | | 100 | 1 |

A typical analysis of a commonly available crushed limestone product is set forth in Table B:

TABLE B
Great Lakes
Limestone Chemical Composition

| Compound | % of Sample |
|---|---|
| Calcium Carbonate | 98.2 |
| Magnesium Carbonate | 1.36 |
| Silica | 0.23 |
| Aluminum | 0.08 |
| Iron | 0.13 |
| Sulfur | 0.06 |
| Total Available Carbonate | 99.54 |

Once the annulus 55 is filled with the acid-neutralizing compound, the lid 28 is sealed to the inner shell 9 by snapping the o-ring 30 past the undercut 34 in the inner wall of the inner shell 9 thereby completing the inner shell assembly.

Once the acid-neutralizing filter is assembled, the filtering apparatus is ready to be completed. A coiled spring 111 is seated on a depression 120 on the exterior of the lid 28. The spring 111 is preferably a coil spring formed from steel and has a spring force of about 35 to about 50 psi. The housing 1 is then slid over the spring/inner shell combination so that the spring seats between the inner wall of the closed end of the housing and the depression 120.

A base plate adapter seal 143 is then provided to effect a seal between the inner shell 9 and the base plate/seaming lid assembly. The base plate adapter seal 143 is preferably formed from nitrile or another suitable rubber compound. The seal 143 includes a first lip 144, a body portion 145, and a second lip 146. The body portion engages the flat portion of the partially closed end 17 of the inner shell and a portion of the base plate 151 while the first lip engages the inner wall of the inner shell central opening 25.

A base plate/seaming lid assembly 113 is then required to complete the assembly. The base plate 151 preferably includes a conventional threaded passage which engages the threads on the apparatus post (not shown). Alternatively, the apparatus may be bolted or otherwise connected to the fluid circulation system. The base plate 151 also comprises a slanting first wall segment 159 which includes inlet ports 161, through which the fluid to be filtered passes, and, preferably, an upturned internally threaded segment 155 which is suitable for engaging an oil inlet post (not shown). Preferably, the inlet ports 161 are arranged angularly in a circular array around the perimeter of the threaded passage 155 and are located within the slanted first wall segment 159 of the base plate.

Inlet fluid enters through the inlet ports 161 and the base plate adapter seal 443 prevents this inlet fluid from bypassing the filters and returning directly to the engine without filtration. The base plate 151 also includes a transition section 165 that extends outward from the slanted first wall segment 159 above the inlet ports 161. The base plate 151 further comprises an outer rim 167, which is attached to the outermost portion of the transition section 165 and is positioned adjacent the outer open end of the housing 1.

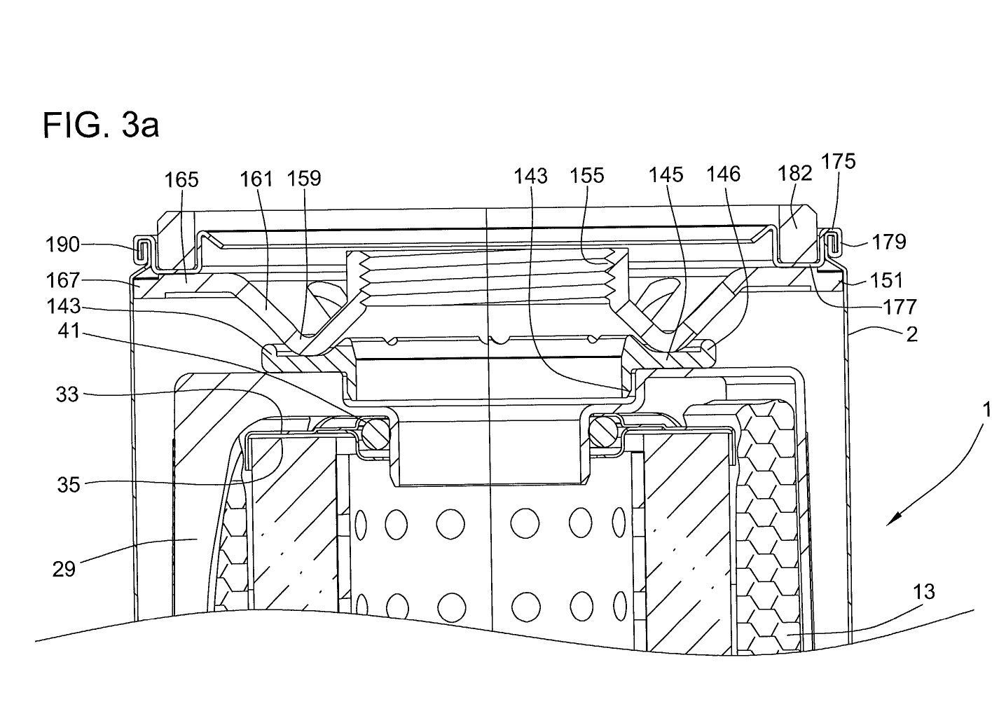

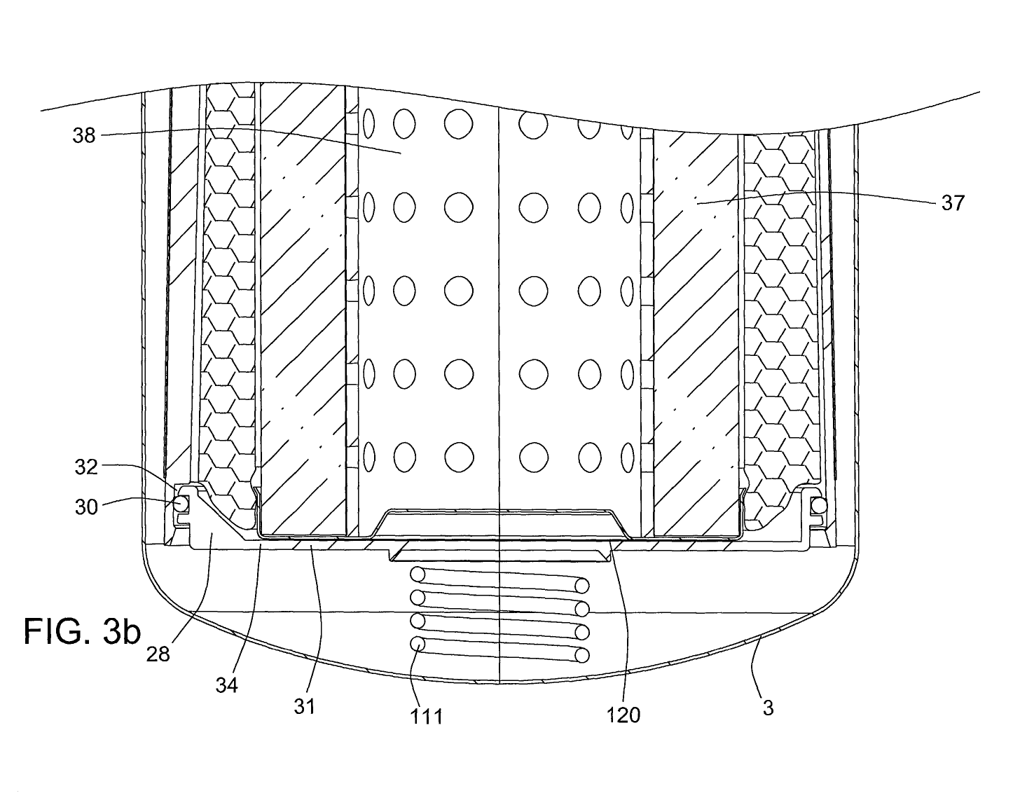

A seaming lid 175 is then attached to the base plate 151 and to the open end of the housing 1, as seen in FIG. 3a. The seaming lid 175 preferably comprises a circular ring having an interior circular groove 177 that consists of an unshaped channel with its open end facing towards the open end of the housing 1, and a downward turn outer rim 179 that surrounds the exterior of the seaming lid and protrudes beyond the periphery of both the base plate 151 and the housing 1. Preferably, the seaming lid 175 is applied by placing the bottom side of the portion of the seaming lid that forms the circular groove 177 within the outer rim 167 of the base plate, and welding the bottom side of the seaming lid at the circular groove 177 to the transition section 165 of the base plate. Preferably, this welding of the base plate 151 and seaming lid 175 occurs before sealing the filter.

A circular seal 182 is placed within the circular groove 181. The circular seal 182 engages the apparatus, such as an engine, to effect a seal to prevent leakage of the outlet fluid passing from the apparatus to the filter. The circular seal 182 may take the form of any of such well-known seals (e.g., a gasket) and preferably is smooth on the exterior surface. Preferably, the circular seal 182 is in the form of a flat seal that includes an undercut portion that fits within the circular groove 181 which assists in holding the circular seal 182 in place.

The seaming lid 175, preferably welded to the base plate 151 as described above, is applied to the filter of the present invention, compressing the spring 111. As seen in FIG. 3a, the outer rim of the seaming lid, which is elevated above the circular groove 181, and which extends beyond the periphery of the base plate 151 and the housing 1, forms a channel into which the periphery of the open end of the housing 1 can fit. Preferably, the housing 1 further comprises a slightly overturned outer lip that extends beyond the periphery of the housing 1. When the elements of the filter apparatus are assembled as described above, the outer rim 190 of the seaming lid and the outer lip of the housing are subsequently turned over (crimped) thereby sealing the contents of the filter within the housing 1.

During attachment of the base plate/seaming lid assembly, the spring 111 is compressed between the interior of the closed end of the housing 1 and the depression 120 on the exterior of the lid 28 of the inner shell 9. The compression of the spring ensures that the lid 28 will not separate from the inner shell and also ensures that the

After the filter assembly is prepared, the fluid such as oil enters through the base plate inlet ports and then enters the acid-neutralizing shell 305 through the inlet ports 330. The fluid passes through the acid-neutralizing compound where the acids in the fluid are neutralized. The oil then flows through any pre-filter, the particulate filter media, through the perforated support screen, and through the conduit inlet ports. Once in the conduit, the treated and filtered fluid passes through the conduit, out the central opening of the acid-neutralizing shell 305 and out the base plate central outlet. In this manner, any particulates carried in the fluid, such a particles of the acid-neutralizing compound, are removed from the fluid before the fluid re-enters the fluid circulation system. Should such particulates enter a fluid circulation system such as an oil system on a diesel engine, the particulates could damage the engine.

In the manner explained above, the acid-neutralizing filter effectively neutralizes acids in the filtered fluid from a pre-determined amount of fluid. However, the present invention is not limited to the features explained above; rather, many modifications and alternations can be conceived by those skilled in the art within the scope of the invention. For instance, the particulate and acid-neutralizing filters may be formed in various manners and of various materials as mentioned above.

All of the references cited herein, including patents, patent applications, and publications, are hereby incorporated in their entirety by reference. The use of the terms “a” and “an” and “the” and similar referents (e.g., “a base plate” or “the bypass conduit”) in the context of describing the present invention (especially in the context of the following claims) should be construed to cover both the singular and the plural, unless otherwise indicated herein or clearly contradicted by context.

While this invention has been described with an emphasis upon the preferred embodiments, it will be obvious to those of ordinary skill in the art that variations of the preferred embodiments can be used and that it is intended that the invention can be practiced otherwise than as specifically described herein. Accordingly, this invention includes all modifications encompassed within the spirit and scope of the invention as defined by the following claims.

What is claimed is:

1. A filter apparatus for use in removing impurities contained in a fluid comprising:
a housing having a closed end and an open end;
an inner shell having an open end and a partially closed end;
a perforated conduit contained in the inner shell;
a particulate filter positioned within the inner shell and arranged concentrically around the perforated conduit; and
an acid-neutralizing compound contained within the inner shell arranged concentrically around the particulate filter.

2. The filter apparatus of claim 1, further comprising a lid which engages the open end of the inner shell.

3. The acid-neutralizing canister according to claim 2, wherein the lid snaps into engagement with the shell.

4. The acid-neutralizing canister according to claim 3, wherein the lid includes an outer seal for sealingly engaging the interior of the inner shell.

5. The acid-neutralizing canister according to claim 4, wherein the seal is an o-ring seal.

6. The acid-neutralizing canister according to claim 1, wherein the particulate filter and perforated conduit is sealingly engaged by first and second end caps.

7. The acid-neutralizing canister according to claim 1, wherein the acid-neutralizing compound is selected from the group consisting of crushed limestone, calcium carbonate, and magnesium carbonate.

8. The filter apparatus of claim 1 further comprising a spring located between the inner shell and the closed end of the housing.

9. A filter apparatus for use in removing acids and impurities contained in a fluid by filtration comprising:
a housing;
an inner shell;
a particulate filter contained in the inner shell, the particulate filter including filter media;
a pre-filter surrounding the filter media;
an acid-neutralizing compound within the inner shell and surrounding the particulate filter and pre-filter; and
a base plate.

10. The filter apparatus according to claim 9, wherein the base plate is a combination base plate and seaming lid.

11. The filter apparatus according to claim 9, wherein the acid-neutralizing compound is selected from the group consisting of crushed limestone, calcium carbonate, and magnesium carbonate.

12. The filter apparatus of claim 9, wherein the base plate includes a central hub, an outer peripheral rim surrounding the hub, and a plurality of radially extending ribs connecting the hub and the rim, the central hub defining a threaded central opening for spin-on on connection to a fluid circulation system.

13. The filter apparatus of claim 12, wherein the central threaded opening of the base plate provides a central port for fluid returning to the fluid circulation system and wherein a plurality of peripheral ports defined between the hub, the ribs and the peripheral rim provide for fluid entering the filter from the fluid circulation system.

14. The filter apparatus of claim 12, wherein the fluid circulation system is an oil circulation system and the fluid is oil.

15. The filter apparatus of claim 13, wherein the acid-neutralizing compound is selected from the group consisting of crushed limestone, calcium carbonate, and magnesium carbonate.

16. A method of removing impurities contained in a oil circulating in an oil circulation system, the method comprising:
(a) introducing the oil to a filtering apparatus including a housing and an inner shell; having within the inner shell, a particulate filter and an acid-neutralizing compound;
(d) passing the oil first into the housing and then into the inner shell;
(e) then passing the oil through an acid-neutralizing compound;
(e) next, passing the oil through a particulate filter; and
(f) passing the oil out of the inner shell and thereafter out of the apparatus, returning the oil to the oil circulation system.

17. The method of claim 16, wherein the acid-neutralizing compound is selected from the group consisting of crushed limestone, calcium carbonate, and magnesium carbonate.
